(19) United States
(12) Patent Application Publication
(10) Pub. No.: US 2013/0031822 A1
(43) Pub. Date: Feb. 7, 2013

(54) ARTIFICIAL BAIT FEATURING AN OVERMOLDED FISH ATTRACTANT SPONGE AND PORTS THROUGH WHICH FISH ATTRACTANT EXUDES

(71) Applicants: Michael Reeves, Orange Park, FL (US); Harry Bell, Middleburg, FL (US); Robert H. Reeves, Odessa, FL (US)

(72) Inventors: Michael Reeves, Orange Park, FL (US); Harry Bell, Middleburg, FL (US); Robert H. Reeves, Odessa, FL (US)

(73) Assignee: STINKY FINGER BAIT COMPANY INCORPORATED, Odessa, FL (US)

(21) Appl. No.: 13/197,995

(22) Filed: Aug. 4, 2011

(51) Int. Cl. A01K 85/01; A01K 85/00; A01K 99/00

(52) U.S. Cl. 43/42.06; 43/42.53; 43/42.24

(57) ABSTRACT

An artificial bait features an overmolded fish attractant sponge and ports through which fish attractant exudes. The bait is comprised of a soft resilient plastic. A container portion of the bait houses the sponge. The container portion includes perforations for fluid communication with the housed sponge. Prior to injection molding, the sponge is a dry compressed cellulose sponge. The sponge is coated with oil prior to injection molding. Pins or blades in the mold assembly position the oil-coated, compressed, cellulose sponge in the container portion of the bait. The pins or blades also define perforations in the container portion for fluid communication with the sponge. The oil coating on the compressed cellulose sponge prevents molten plastic from impregnating the sponge during the injection molding process. The oil coating does not cause the sponge to expand. After manufacture, a water-based fish attractant is introduced into and absorbed by the sponge via the perforations. The fish attractant may be replenished periodically.

### FIELD OF THE INVENTION

This invention relates generally to fishing, and, more particularly, to an artificial bait.

### BACKGROUND

Many species of fish have an extremely well-developed sense of smell, even though they inhabit an aquatic environment. With olfactory nerves in their nostrils, fish can detect odors in water just as terrestrial animals can detect odors in air. Four nostrils are located close to the top of the snout, one pair on each side. Each pair opens into a small blind sac immediately below the skin. Water, carrying odors, passes through the sacs, which are lined with the receptors of smell.

Some fish use their sense of smell to identify mating partners, find food, detect danger, and perhaps also to find their way to spawning areas. Salmon can detect one part per billion of odorous material in water. They may refuse to use fish ladders if the water contains the smell of human hands or bear paws. Salmon also utilize their sense of smell to identify and return to their home stream waters. Catfish use their sense of smell to identify other catfish and to maintain a social hierarchy. Many fish use olfaction to identify mating partners or to detect the presence of food. Some species of sharks are able to detect as little as one part per million of blood in seawater. They can pick up and follow a blood trail for miles, always making adjustments as they perceive a minute difference in intensity level. A largemouth bass will use its senses of hearing, sight, vibration, and smell to attack and seize its prey.

There is a close relationship between the senses of smell and taste in fish, just as in humans. Many types of fish are first drawn to food by its odor. For example, catfish and sturgeon, which are first attracted by food odor, will feel and taste the food with their chin barbells before taking it. These whisker-like appendages contain taste buds. Some catfish have taste buds all over their bodies.

When a fish senses the presence of plastic bait, it may investigate the movement. As the fish approaches, it expects taste and a final stimulus, smell, to emanate from the prey. As the fish crushes the prey with its hard, teeth-lined, bony mouth, the fish expects the flavor and scent of the prey to be released. If that does not happen, in many cases the fish will abandon the bait.

Thus, to exploit fish olfaction to the advantage of anglers, bait should not only emit a trail of attractant as it is drawn through the water, but should exude the scented attractant when struck by a fish. Unfortunately, conventional scented baits are not highly responsive to a fish strike and suffer other shortcomings.

Many scented attractants are oil-based. Oil-based scents tend to form large (hydrophobic) water resistant trails of droplets that disperse in water under the influence of water current or movement of the bait relative to the water. These trails comprise unnatural concentrations of attractant. While water soluble (hydrophilic) scents disperse more naturally, they have a tendency to wash off bait so rapidly that it must be reapplied often, almost every cast. Not only is repeated reapplication time-consuming and tedious, but it leads to waste, messes and is often ineffective. Such attractants do not adhere well to wet bait. Thus, if the bait is not thoroughly dried before reapplication, the attractant tends to leave the bait during casting. If any is left when the bait strikes the water, it dissipates almost immediately.

What is needed is a bait that retains water or oil based attractants during casting, whether or not the bait is wet or dry, and emits a burst of attractant in response to a fish strike. Such bait should also be cost-effective, easy to manufacture, reusable and easy to replenish with attractant, without spillage, overspray or mess.

The invention is directed to overcoming one or more of the problems and solving one or more of the needs as set forth above.

### SUMMARY OF THE INVENTION

To solve one or more of the problems set forth above, in an exemplary implementation of the invention, artificial bait featuring an overmolded fish attractant sponge and ports through which fish attractant exudes is provided. The bait is comprised of a soft resilient plastic. A container portion of the bait houses the sponge. The container portion includes perforations for fluid communication with the housed sponge. Prior to injection molding, the sponge is a dry compressed cellulose sponge. The sponge is coated with oil prior to injection molding. Pins or blades in the mold assembly position the oil-coated, compressed, cellulose sponge in the container portion of the bait. The pins or blades also define perforations in the container portion for fluid communication with the sponge. The oil coating on the compressed cellulose sponge prevents molten plastic from impregnating the sponge during the injection molding process. The oil coating does not cause the sponge to expand. After manufacture, a water-based fish attractant is introduced into and absorbed by the sponge via the perforations. The fish attractant may be replenished periodically.

An artificial bait according to principles of the invention includes a flexible resilient body containing an oil-coated attractant sponge; and a plurality of perforations in the flexible resilient body leading to the oil-coated attractant sponge. A fish attractant can be absorbed in the sponge. The sponge may be a dry, compressed, cellulose sponge, which can absorb a fish attractant after the injection molding process is completed. The flexible resilient body may be molded over the sponge. The oil-coated attractant sponge may be coated with fish oil. The plurality of perforations may be open, partially open, or substantially closed. In the case of partially open and substantially closed perforations, the perforations will flex open when the bait is pinched but remain only partially open or substantially closed when the bait is in a relaxed state. The perforations are channels in the flexible resilient body formed from a plurality of pins in an injection mold in which the flexible resilient body is formed. The plurality of pins support and position the sponge in the flexible resilient body during injection molding. The flexible resilient body includes a container portion and a body portion. The container portion of the flexible resilient body swells (i.e., expands in diameter) when an attractant is absorbed by the contained oil-coated attractant sponge. The artificial bait may be configured so that the container portion swells to a desired diameter. Such configuration involves controlling the diameter of the sponge and the thickness and modulus of material surrounding the contained sponge. The attractant sponge may be repeatedly replenished with attractant by squeezing the container containing the sponge, and allowing the sponge to expand while exposed to (e.g., immersed in) a liquid attractant.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a perspective view of an exemplary plastic bait according to principles of the invention; and

FIG. 2 is a top view of an exemplary plastic bait according to principles of the invention; and

FIG. 3 is a view of section (A-A) of the exemplary plastic bait of FIG. 2 according to principles of the invention; and

FIG. 4 is a perspective view of an exemplary oil covered sponge for a plastic bait according to principles of the invention; and

FIG. 5 is a perspective view of a section of an exemplary oil covered sponge for a plastic bait according to principles of the invention; and

FIG. 6 is a perspective view of an exemplary mold piece for molding a plastic bait according to principles of the invention; and

FIG. 7 is a perspective view of another exemplary mold piece for molding a plastic bait according to principles of the invention; and

FIG. 8 is a high level flowchart of an exemplary method for producing plastic bait according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the configurations, shapes, relative sizes, ornamental aspects or proportions shown in the figures.

### DETAILED DESCRIPTION

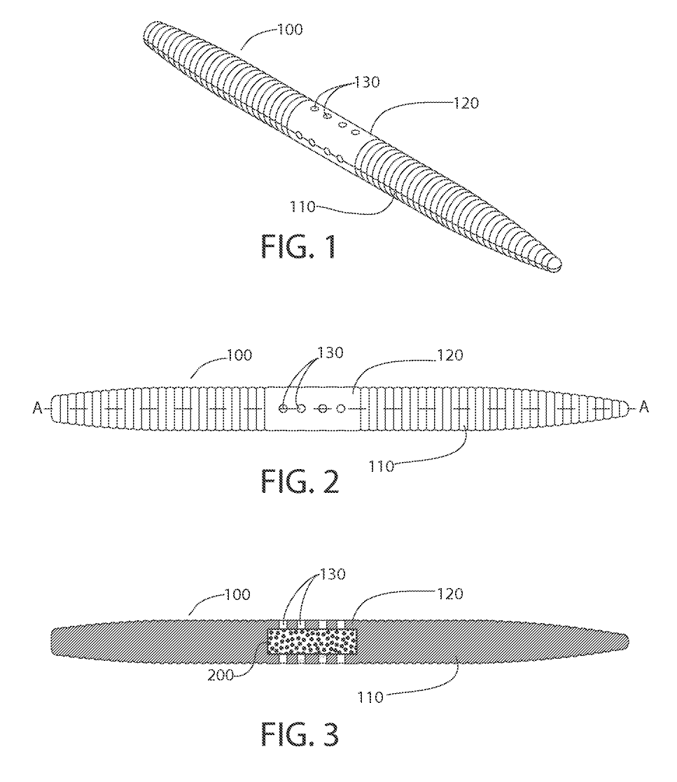

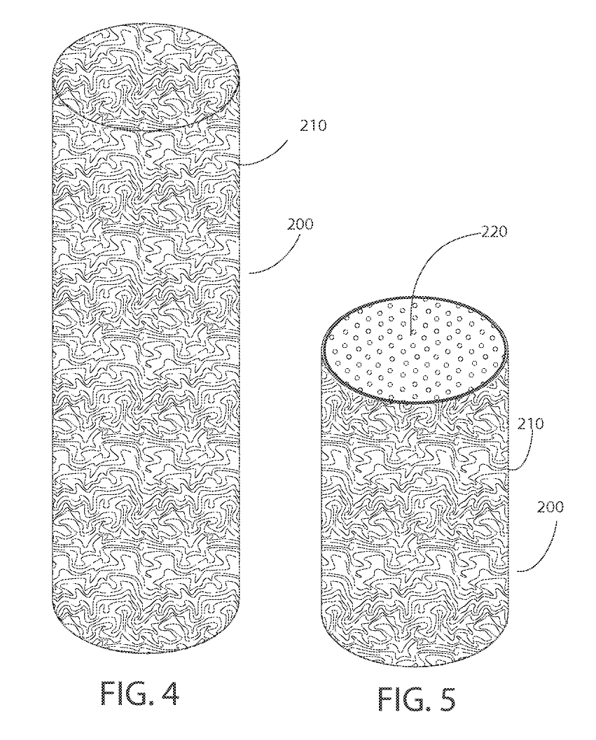

In an exemplary embodiment, a soft plastic bait 100 according to principles of the invention comprises a body 110 of flexible resilient plastic-based material, as conceptually illustrated in FIGS. 1 and 2. While worm-shaped bait 100 is shown, the invention is not limited to any particular bait shape. Instead, the body 110 may be configured and shaped to generally imitate any natural aquatic prey or any other shape suitable for luring a fish. Such other shapes and configurations include, but are not limited to, worms with and without tails, lizards, grubs, minnows, flukes, crawfish, tubes, frogs, eels, shrimp, squid and other fish, amphibian, insect and animal mimics.

Regardless of the shape and configuration of the body 110, a portion of the bait 100 comprises an integrally formed container 120 that houses an attractant sponge 200. The container 120 is comprised of the same material as the body 110. The container 120 is integrally formed with the body 110. The container 120 is formed over the attractant sponge 200.

A plurality of perforations 130 provides fluid access to the contents of the container 120 (i.e., the attractant sponge 200). The perforations may be permanently fully open in a relaxed state, partially open in a relaxed state, or substantially closed in a relaxed state. Fully open perforations provide an open channel to the contents of the container at all times unless the channel is pinched closed. Partially open perforations provide a channel to the contents of the container which may be expanded or closed depending upon deformations caused by applied physical forces. Substantially closed perforations provide closed channel to the contents of the container at all times unless the channel is urged open by applied forces. Such applied forces may be an angler's pinch or squeeze to release fish attractant from the contents of the container 120 or a fish strike that causes attractant to exude through the perforations 130. Thus, an angler or fish may open or closed the channel, causing more or less fluid communication between the contents of the container 120 and the exterior. The perforations may be formed with relatively narrow (e.g., flat blade-like) or wide (e.g., 0.25 to 1 mm diameter circular cross section) pins in a mold. Thus, the various perforations may be formed using pins of various shapes. Illustratively, a flat pin may form substantially closed perforations, while a wide round pin may form substantially open perforations, and a teardrop-shaped pin may form a partially open perforation.

As shown in FIG. 3, the container 120 houses an attractant sponge 200. As used herein, the term sponge broadly refers to a porous absorbent mass. The sponge comprises a porous absorbent pith or core particularly useful for absorbing liquids. In an exemplary embodiment, the sponge is a dry, compressed, cellulose sponge. The body 110 and container 120 are formed over the sponge 200. The sponge 200 absorbs and exudes liquid fish attractant.

To avoid impregnation with plastic during the molding process, the sponge core 220 is coated with a layer of oil 210 before molding. Coating the sponge core 220 with oil does not cause expansion of the dry compressed sponge 200. Concomitantly, the oil 210 prevents intrusion of liquid plastic into the core 220 of the dry compressed sponge 200. In a preferred embodiment, the oil 210 comprises fish oil derived from the tissues of oily fish.

The oil coating 210 is important. If the sponge was not coated with a protective layer before molding the bait, then the liquid plastic from which the bait is formed would intrude into the sponge core, saturate its open cells, and trigger expansion of the sponge. When the plastic cures (i.e., hardens), the sponge would no longer be able to absorb any other liquids. This would defeat the utility of the sponge. The oil coating 210 not only prevents plastic intrusion throughout molding, but also allows absorption of water-based liquids after the bait has been made.

After the bait is manufactured, an attractant is introduced into the sponge 200 through the perforations 130. A water-based attractant, rather than an oil-based attractant, is used. The water-based attractant activates the sponge, slowly permeating the oil and filling open cells of the sponge. As the oil-soaked sponge slowly absorbs the attractant, the sponge expands. The expansion exerts forces outwardly on the container. Depending upon the configuration (e.g., thinness or thickness of the container walls, size of the sponge and flexibility of the material comprising the bait), the container may swell or substantially maintain its original shape under the influence of the expanding forces of the sponge 200.

The bait 100 may be designed with a container 120 that swells to a desired shape when the sponge 200 becomes saturated. In such cases, the molded product may feature a narrow container 120 (e.g., a slightly tapered portion of the bait 100) that expands when attractant and/or water saturates the contained sponge.

The oil and attractant may be replenished from time to time. After use, the container 120 of the bait 100 may be squeezed, thereby compressing the contained sponge 200. The sponge releases liquid when compressed. Afterwards, fresh oil and/or attractant may be introduced into the sponge 200 by placing the bait 100 in a plastic bag containing a substantial amount attractant. The bait may simply be left in the oil and/or attractant to allow the sponge to absorb the liquid, or the container may be squeezed to accelerate absorption. Upon squeezing the container 120 and allowing it to return to an uncompressed state, the contained sponge 200 absorbs liquid.

Bait according to principles of the invention offers several advantages. During casting, the sponge 200 within the container 120 retains attractant. When the bait 100 hits and enters a body of water, the saturated sponge 200 exudes attractant slowly through the perforations 130. When struck and compressed by a fish bite, the bait 100 emits a burst of attractant in a manner similar to injured prey. Because the bait may use a water-soluble (hydrophilic) attractant, the attractant disperses more evenly naturally than an oil-based. Additionally, the dispersed water based attractant covers a much larger area and covers the area more quickly than the concentrated insoluble (hydrophobic) trail of concentrated droplets characteristic of oil-based attractants.

The bait 100 is comprised of a flexible resilient plastic, suitable for use in molding processes. By way of example and not limitations, soft plastic compounds such as compounds based on polyvinyl alcohol (PVOH) or highly plasticized polyvinyl chloride (PVC), such as plastisol, or any other moldable soft plastic compound now known or hereafter developed.

While various plastic forming processes may be utilized to form bait 100 according to principles of the invention, in an exemplary implementation the bait 100 is formed by molding, and preferably by injection molding. Thermoplastic material is injected into a mold assembly with a bait-shaped cavity and then allowed to cure.

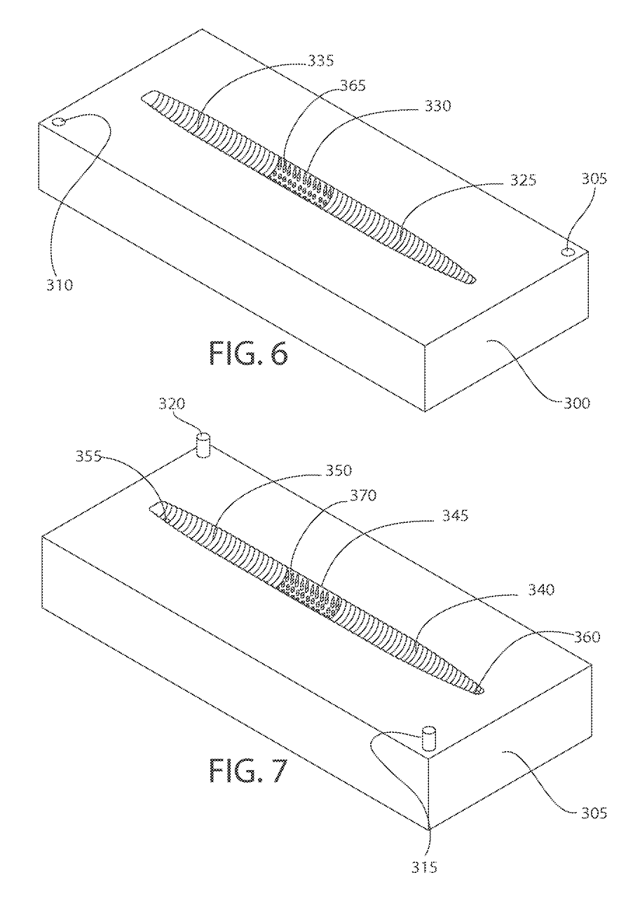

With reference to FIGS. 6 and 7, the injection mold assembly comprises mold plates 300, 305 that mate to define an internal cavity that conforms to the shape of the desired product. To facilitate alignment during mating, the plates 300, 305 may include engaging male pins 315, 320 and female sockets 305, 310 or other alignment devices.

In the illustrative embodiment depicted in FIGS. 6 and 7, the cavity includes head 325, 340, container 330, 345 and tail 335, 350 sections. The container section 330, 345 includes a plurality of protruding pins 365, 370 or blades to support a compressed oil-coated cellulose sponge 200. The pins 365, 370 or blades position the sponge at the center of the container section 330, 345 of the mold assembly, or fore or aft of the center. The pins 365, 370 or blades also define the perforations 130 in the container 120, which provide a channel for fluid communication with the contained sponge 200.

The cavity defined by the mold plates 300, 305 communicates with at least one injection port 355 and at least one ventilation port 360 to facilitate the injection process. The thermoplastic material is injected into the injection port 355 and the ventilation port 360 allows the air inside the mold to escape. Injection and ventilation ports and channels may be arranged in almost any desired configuration suitable for the molding process. The particular configuration and location of injection and ventilation ports may be varied without departing from the scope of the invention.

The mold plates of FIGS. 6 and 7 are illustrated primarily to depict the pins or blades for supporting the oil-coated sponge and defining perforations and corresponding channels for fluid communication with the sponge. The invention is not limited to a single cavity mold assembly, nor is the invention limited to the configurations and shapes shown in the Figures. Additional and different mold assembly features and components may be utilized without departing from the scope of the invention.

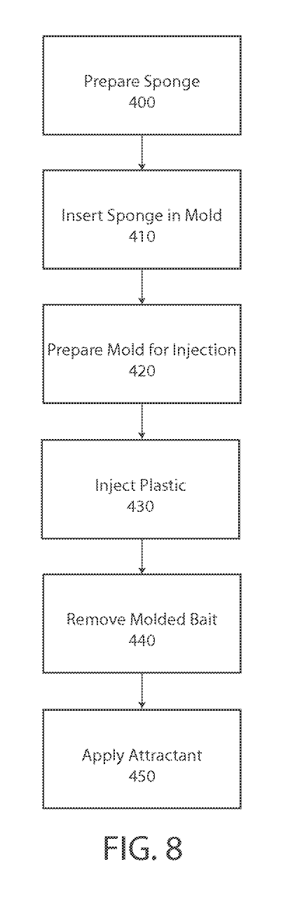

With reference to the flow chart of FIG. 8, a method of producing an artificial bait featuring an overmolded fish attractant sponge and ports through which fish attractant exudes is provided. Initially, the sponge is prepared for molding, as in step 400. A dry, compressed cellulose sponge is coated with oil, such as a fish oil. After preparation, the sponge 200 is placed (i.e., inserted) in the mold assembly on the pins or blades at the container section, as in step 410. After the sponge 200 has been properly inserted, the mold is prepared for injection molding, as in step 420. This step may include all of the steps normally undertaken for injection molding, including coupling the injection port(s) to the injection molding equipment. After the mold has been prepared, thermoplastic compound is heated to a molten state and injected into the cavity of the mold, in accordance with step 430. As the molten compound enters the mold cavity through the injection port, entrapped air escapes through the ventilation port. The molten plastic compound fills the cavity and surrounds the sponge. Because the dry compressed sponge has been coated with oil, the molten plastic will not impregnate the sponge during injection molding. After injection, the molten plastic compound is allowed to partially or fully cure. Then the molded bait is removed from the mold by disassembling the mold assembly and withdrawing the bait from the cavity, as in step 440. Attractant may then be introduced into the sponge 200 via the perforations 130 in the container 120, as in step 450.

The attractant may be introduced into the sponge 200 by placing the bait 100 in a plastic bag containing a substantial amount of liquid attractant. The bait may simply be left in the attractant to allow the sponge to absorb the liquid, or the container 120 portion of the bait 100 may be squeezed to accelerate absorption. Over time, the sponge will absorb substantial liquid attractant through capillary action. Upon squeezing the container 120 and allowing it to return to an uncompressed state, the contained sponge 200 draws in and absorbs liquid attractant from the bag.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. An artificial bait comprising:
a flexible resilient plastic body injection molded onto and containing an oil-coated attractant sponge, said flexible resilient plastic body being formed directly on said oil coated attractant sponge and permanently containing said attractant sponge; and
a plurality of perforations in the plastic body leading to the oil-coated attractant sponge;
said oil-coated attractant sponge comprising a core sponge and an outer coating, said outer coating comprising an oil that prevents infiltration of the sponge with plastic resin during molding but allows the sponge to subsequently absorb a liquid attractant.

2. An artificial bait according to claim 1, further comprising a water-based fish attractant absorbed in the attractant sponge.

3. An artificial bait according to claim 1, said attractant sponge comprising a dry, compressed, cellulose sponge.

4. An artificial bait according to claim 1, said flexible resilient plastic body being adapted to compress the attractant sponge when the flexible resilient plastic body is compressed.

5. An artificial bait according to claim 1, said oil-coated attractant sponge being coated with fish oil.

6. An artificial bait according to claim 1, said plurality of perforations being open.

7. An artificial bait according to claim 4, said plurality of perforations including perforations that are partially open when the flexible resilient body is in a relaxed state and substantially open when the flexible resilient body is in a stressed state.

8. An artificial bait according to claim 4, said plurality of perforations including perforations that are substantially closed when the flexible resilient body is in a relaxed state and substantially open when the flexible resilient body is in a stressed state.

9. An artificial bait according to claim 4, said plurality of perforations including perforations that are partially open when the flexible resilient body is in a relaxed state and substantially open when the flexible resilient body is pinched.

10. An artificial bait according to claim 4, said plurality of perforations including perforations that are substantially closed when the flexible resilient body is in a relaxed state and substantially open when the flexible resilient body is pinched.

11. An artificial bait according to claim 4, said plurality of perforations comprising channels in the flexible resilient body formed from a plurality of pins in an injection mold in which the flexible resilient body is formed.

12. An artificial bait according to claim 4, said plurality of perforations comprising channels in the flexible resilient body formed from a plurality of pins in an injection mold in which the flexible resilient body is formed, said plurality of pins supporting and positioning the sponge in the flexible resilient body during injection molding.

13. An artificial bait according to claim 4, said flexible resilient body including a container portion and a body portion, the container portion of the flexible resilient body containing the oil-coated attractant sponge.

14. An artificial bait according to claim 4, said flexible resilient body including a container portion and a body portion, the container portion of the flexible resilient body containing the oil-coated attractant sponge and swelling when an attractant is absorbed by the oil-coated attractant sponge.

15. An artificial bait according to claim 4, said flexible resilient body including a container portion and a body portion, the container portion of the flexible resilient body containing the oil-coated attractant sponge having a first diameter when the oil-coated attractant sponge is not saturated and swelling to a second diameter when an attractant is absorbed by the oil-coated attractant sponge.

16. An artificial bait with an attractant sponge that may be repeatedly replenished with attractant, said artificial bait comprising:
a flexible resilient body injection molded directly onto and permanently containing an oil-coated attractant sponge, said oil-coated attractant sponge comprising a core sponge and an outer coating, said outer coating comprising an oil that prevents infiltration of the sponge with plastic resin during molding but does not prevent the sponge from subsequently absorbing a liquid attractant; and
a plurality of perforations in the flexible resilient body leading to the oil-coated attractant sponge, said attractant sponge being effective for absorbing a liquid fish attractant, and said core sponge further being compressible to emit absorbed liquid and expandable following compression upon which expansion liquid is drawn into the core sponge.

17. An artificial bait according to claim 16, further comprising a liquid fish attractant absorbed in the core sponge.

18. An artificial bait according to claim 17, said attractant core sponge comprising a cellulose sponge.

19. An artificial bait according to claim 18, said flexible resilient body being a plastic molded over the oil-coated attractant sponge.

20. An artificial bait according to claim 19, said flexible resilient body swelling when an attractant is absorbed by the oil-coated attractant sponge.
